(19) United States
(12) Patent Application Publication
(10) Pub. No.: US 2015/0364019 A1
(43) Pub. Date: Dec. 17, 2015

(54) SHEET CASTING WITH INTEGRATED CABLES

(71) Applicant: Checkpoint Systems, Inc., Thorofare, NJ (US)

(72) Inventors: Haiming Gu, Shanghai (CN); Jianrui Zheng, Shanghai (CN)

(21) Appl. No.: 14/736,449

(22) Filed: Jun. 11, 2015

(30) Foreign Application Priority Data
Jun. 12, 2014 (CN) 2014102622818

(51) Int. Cl. G08B 13/24; H01Q 1/22; H01Q 7/00

(52) U.S. Cl. CPC G08B 13/2434; G08B 13/244; H01Q 7/00; H01Q 1/2216

(57) ABSTRACT

A method of integrating antenna wiring into a sheet, e.g., an acrylic sheet. The method includes routing wire elements relative to brackets on a first plate to form detection loops. The method further includes providing a seal around a periphery of the detection loops, enclosing the detection loops between the seal, forming a void space between the first plate and a second plate, providing liquid material into the void space to form a filled casting mold, baking the filled casting mold so that the liquid material can harden, and removing the first plate and second plate to generate a sheet with the detection loops integrated therein.

### TECHNICAL FIELD

Various example embodiments relate generally to retail theft deterrent and merchandise protection devices and methods.

### BACKGROUND

Retail stores continuously struggle to improve relative to their capabilities for protecting merchandise items. Given the many different product materials, packaging materials, shapes and sizes of merchandise items, it can be appreciated that protection of such items is rarely accomplished via a “one size fits all” approach. Instead, it is often the case that different styles and functions for security devices are employed for protection of respective different items.

In this regard, for example, some security devices are pinned or otherwise affixed to merchandise items, some security devices are wrapped around merchandise items, and some security devices entirely contain merchandise items or at least a portion of such items. The security devices can also employ different security measures. In some cases, the security devices may activate a local, audible alarm. In other cases, the security devices may activate a gate alarm or other remote notification system. In still other cases, the security device may simply be extremely difficult to open, or may release ink or in some other way devalue the item if the security tag is tampered with.

In systems that employ security gates, the gates may be set up proximate to consumer exits from the retail store. The gates may cooperate to establish an RF field that can detect the presence of a tagged item within the field and alarm when such presence is detected. In some situations, the gates may be erected as pedestals that support an antenna assembly that extends about six feet high from the floor. To improve the aesthetic appearance of the gates, acrylic panes may be employed in a brushed steel frame. Further, some versions of the gates may be almost entirely formed of acrylic panels that have antennas provided therein. The antennas are routed through milled or drilled grooves in the acrylic panels and then covered by silicon rubber. However, the milling/drilling and cable routing processes are both time consuming and costly, and the milling/drilling processes can create sharp edges. Moreover, panels may be susceptible to scratching while being processed. In some cases, coil carrier strength may drop due to stress concentration after machining. Additionally, grooves on the outsides of the panels can make the antennas less elegant than may be desired for certain high-end stores. Thus, an improved design and method of production may be desirable.

### BRIEF SUMMARY OF SOME EXAMPLES

Accordingly, some example embodiments may provide for improved antenna design and methods of production. Production cost and time increases can therefore be avoided, while improved aesthetic appearance and perhaps also performance is achieved.

In one example embodiment, a method of integrating antenna wiring into a sheet (e.g., an acrylic sheet) during a casting process is provided. The method may include routing one or more wire elements relative to a plurality of brackets (e.g., removable brackets) disposed on a first plate to form corresponding detection loops. The removable brackets may be associated with corresponding engagement brackets (e.g., acrylic brackets) that engage the one or more wire elements responsive to the routing of the one or more wire elements. The method may further include removing the removable brackets to leave the one or more wire elements held by the engagement brackets, providing a seal around a periphery of the one or more detection loops, enclosing the one or more detection loops between the seal, the first plate, and a second plate to form a void space, providing liquid material into the void space to form a filled casting mold, baking the filled casting mold and allowing the liquid material to harden, and removing the first and second plates and the seal to generate a sheet with the one or more detection loops integrated therein.

According to another example embodiment, a gate device is provided. The gate device may include a pedestal, a transparent antenna support member and antenna wiring. The pedestal may house control circuitry for the security device detection gate and provide a base for supporting the security device detection gate proximate to an exit of a retail store. The transparent antenna support member may be supported in a vertical orientation relative to a ground plane upon which the pedestal is placed. The antenna wiring may be provided integrally within the transparent antenna support member during a casting process that forms the transparent antenna support member.

In another example embodiment, a system including a plurality of security tags and a security device detection gate is provided. The security tags may each be attached to respective different commercial products. The security device detection gate may be configured to detect the tags responsive to movement of one of the tags proximate to the security device detection gate. The security device detection gate may include a pedestal, a transparent antenna support member, and antenna wiring. The pedestal may house control circuitry for the security device detection gate and provide a base for supporting the security device detection gate proximate to an exit of a retail store. The transparent antenna support member may be supported in a vertical orientation relative to a ground plane upon which the pedestal is placed. The antenna wiring may be provided integrally within the transparent antenna support member during a casting process that forms the transparent antenna support member.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a gate device having a transparent portion that can be produced according to some example embodiments;

FIG. 2 illustrates a perspective view of structures associated with wire element routing to form antenna wiring in accordance with an example embodiment;

FIG. 3 illustrates a closer perspective view of some of the structures of FIG. 2 in accordance with an example embodiment;

FIG. 4 illustrates a perspective view of structures associated with performing a sealing operation relative to wire ends of the wire elements that are routed in connection with the operations described in reference to FIGS. 2 and 3 in accordance with an example embodiment;

FIG. 5 illustrates a perspective view of structures associated with putting detection loops into a casting mold in accordance with an example embodiment;

FIG. 6 illustrates a side view of structures associated with conducting a filling operation associated with the casting process of an example embodiment;

FIG. 7 illustrates a top view of structures associated with milling an outline of a cast acrylic sheet in accordance with an example embodiment;

FIG. 8 illustrates a top view of structures associated with removal of a rubber seal that is used in connection with the casting process according to an example embodiment;

FIG. 9 illustrates a top view of an acrylic sheet that may form a transparent antenna support member of an example embodiment; and

FIG. 10 illustrates a block diagram of a method of integrating antenna wiring into an acrylic sheet during a casting process of a transparent antenna support member according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. As used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may enable provision of a gate device for use in a security device detection gate. The security device detection gate may employ antenna wiring integrally formed in a transparent portion of such device during a casting process used to form the transparent portion. Accordingly, the cost and complexity of milling or drilling holes in the transparent portion may be reduced, and the manufacturer can also eliminate the complexity and cost associated with trying to route antenna wires through milled or drilled holes.

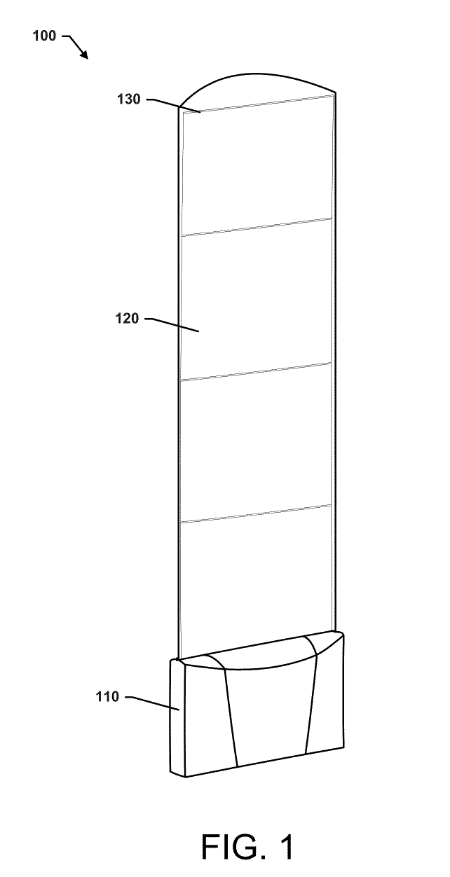

FIG. 1 illustrates an example of a gate device 100 including a pedestal 110 that may benefit by employing an example embodiment. In this regard, the gate device 100 may include the pedestal 110, which sits on the ground and houses various electronics and control circuitry components. The gate device 100 may also include a transparent antenna support member 120 that is supported by the pedestal 110 and extends vertically away from the ground. The transparent antenna support member 120 may include antenna wiring 130 routed therein, in accordance with an example embodiment. The antenna wiring 130 may be routed in the antenna support member 120 during the molding or casting process of the transparent antenna support member 120.

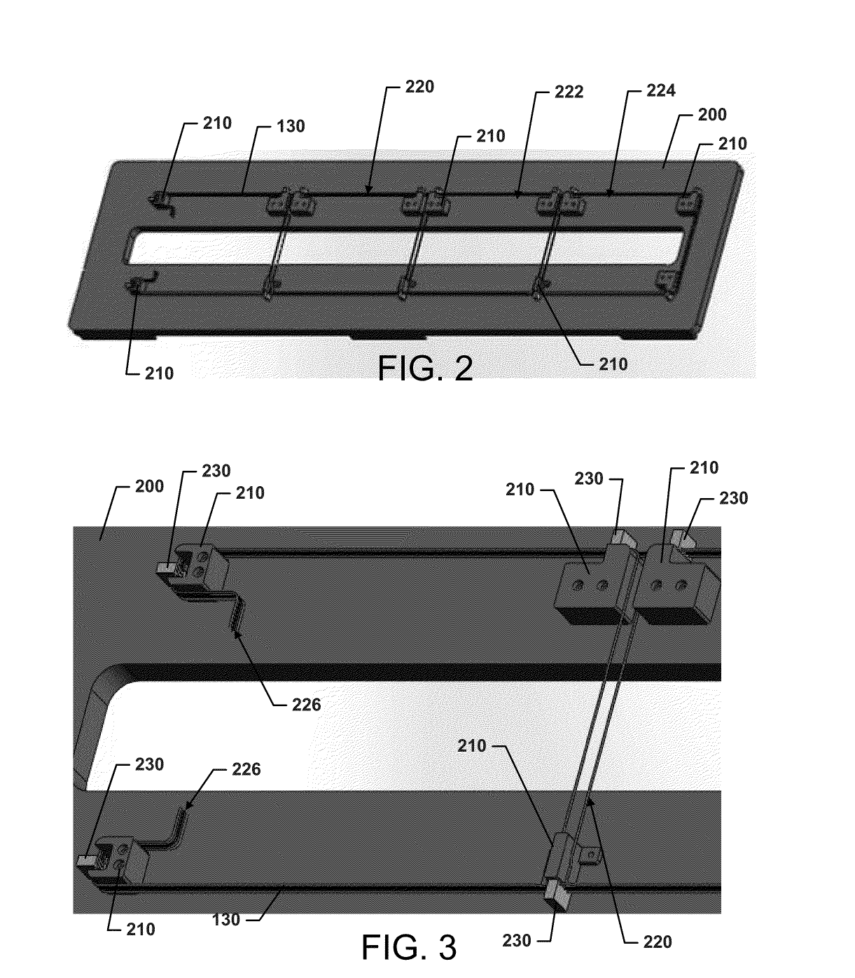

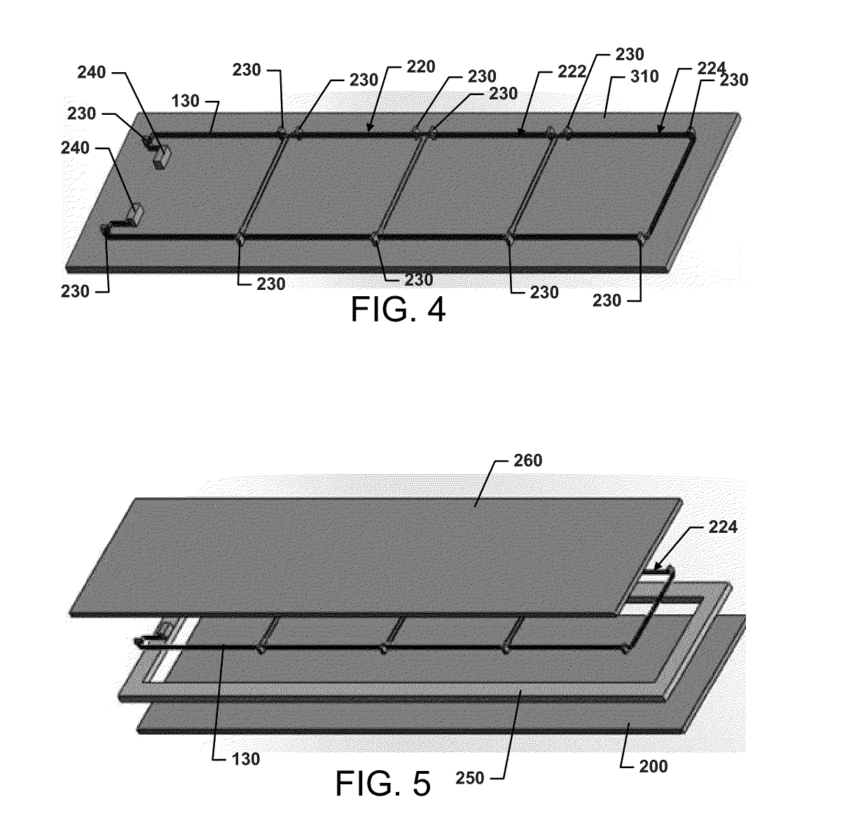

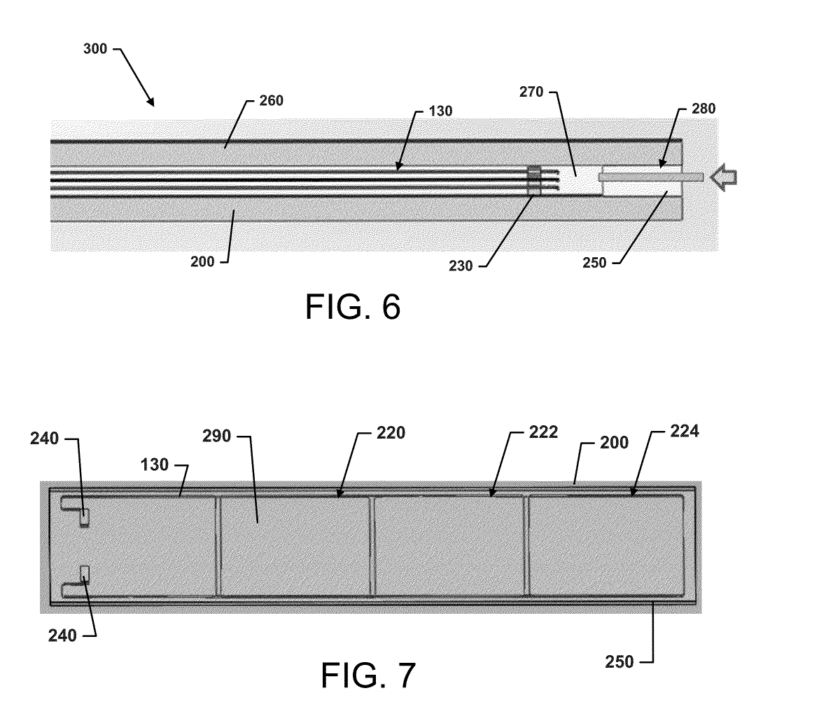

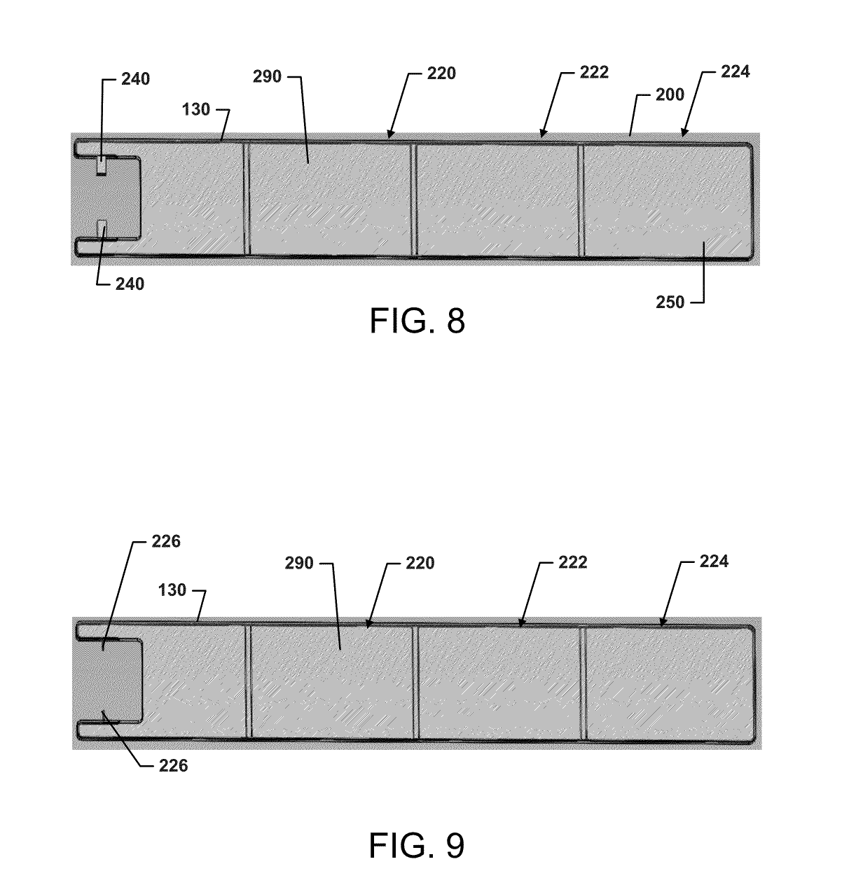

The transparent antenna support member 120 may be, for example, acrylic material that is molded or cast with the antenna wiring 130. In this example, the use of milling and/or drilling to create spaces within the antenna support member 130, through which the antenna wiring 130 can be routed, can be minimized. FIGS. 2-9 illustrate a sequence of events associated with conducting the molding, or casting the antenna wiring 130 within the transparent antenna support member 120, as an integral part thereof. In this regard, FIGS. 2 and 3 illustrate structures associated with wire element (or cable) routing. FIG. 4 illustrates structures associated with performing a sealing operation relative to wire ends of the wire elements that are routed in connection with the operations described in reference to FIGS. 2 and 3. FIG. 5 illustrates structures associated with putting detection loops into a casting mold. FIG. 6 illustrates structures associated with conducting the casting process of an example embodiment. FIG. 7 illustrates structures associated with milling an outline of a cast sheet. FIG. 8 illustrates structures associated with removal of a rubber seal that is used in connection with the casting process. FIG. 9 illustrates the final product after the processes of an example embodiment have been performed.

Referring first to FIG. 2, a cable routing fixture 200 of an example embodiment is provided. The cable routing fixture 200 may be a plate (e.g., a first plate) formed of tempered glass. The cable routing fixture 200 may therefore form a substrate having a substantially rectangular shape, and upon which various components may be fixed to prepare a casting mold in accordance with an example embodiment. In this regard, for example, the cable routing fixture 200 may be provided with a plurality of brackets 210 that are affixed to the cable routing fixture 200 to facilitate routing of the cables forming the antenna wiring 130. In an exemplary embodiment, the brackets 210 may be removable. Copper, tinned copper or other conductive wire elements may be used to form detection loops (e.g., first detection loop 220, second detection loop 222 and third detection loop 224) on the cable routing fixture 200 by wrapping the wire elements around the brackets 210.

In examples, tinned copper may be employed. The tinned copper may have a silver color, which may blend with the acrylic material that will be cast in later phases of the production process. In some examples, single strand wire elements may be employed. In some cases, the single strand wire elements may have a diameter of about 1.6 mm, although other diameters of wire may also be used. The diameter of wire selected should be sufficient to enable the wire elements to be routed and still maintain their shape during the casting process, and performance thereafter.

In some embodiments, screws or any other suitable fixing members may be employed to temporarily affix the brackets 210 to the cable routing fixture 200. In some examples, brackets 210 may be removable. In these examples, the removable brackets 210 may also support and/or provide markers for the placement of corresponding engagement brackets 230. Brackets 230 may be acrylic, and may be made of, for example, polymethyl methacrylate or PMMA. For example, one engagement bracket 230 may be provided on the cable routing fixture 200 in association with each of the removable brackets 210. When the wire elements are routed to form the detection loops (e.g., first detection loop 220, second detection loop 222 and third detection loop 224), the wire elements may also engage the engagement brackets 230.

In an example embodiment, the first, second, and third detection loops (220, 222 and 224) may be arranged next to each other in a line, and may be routed to a common connection terminal location 226. The routing of the wires to the common connection terminal location 226 may be accomplished by arranging the wires of the first, second, and third detection loops (220, 222 and 224) adjacent to each other. In some cases, the wires of the first, second, and third detection loops (220, 222 and 224) may be arranged in alignment with each other in a line that is substantially perpendicular to a surface of the cable routing fixture 200. However, to ensure that the wires do not connect to each other, the engagement brackets 230 may hold the wires spaced apart from each other.

Although the first, second and third detection loops (220, 222 and 224) may be arranged to define substantially rectangular shaped loops, other shapes may also be possible. To facilitate generation of desired loop shapes, in one example the engagement brackets 230 may be provided at respective corners of each of the first, second, and third detection loops (220, 222 and 224) so that the shapes of the first, second and third detection loops (220, 222 and 224), and the spacing between wire elements thereof, can be maintained.

FIG. 3 illustrates a close in view of a portion of the cable routing fixture 200 of FIG. 2. FIG. 3 is intended to show the interaction between the wire elements forming the detection loops of the antenna wiring 130, the brackets 210, and engagement brackets 230. As can be appreciated from FIGS. 2 and 3, in some instances, the antenna wiring 130 forms three layers of loop wires. These layers form the first, second, and third detection loops (220, 222 and 224), respectively. The layers, as mentioned above, may be spaced apart from each other by virtue of the engagement brackets 230.

As shown in FIG. 4, upon completion of the formation of the conductive loops, a casting pane 310 may be used for casting purposes. In an embodiment, the casting pane 310 may assist casting the antenna wiring 130 within a liquid material. In one example, the casting pane 310 may be made of tempered glass, although the casting pane 310 may be made of any material understood in the art of casting. As further shown in FIG. 4, the brackets 210 may be removed after the conductive loops are formed. In some cases, the removable brackets 210 may be removed from the cable routing fixture 200. However, in other cases, the removable brackets 210 may be removed by also removing the cable routing fixture 200 and transferring the antenna wiring 130 to a cable routing fixture (also shown as element 200 but without a gap in central portions thereof) in the form of a rectangular shaped glass plate, as shown in FIGS. 4-9. After removing the removable brackets 210, the engagement brackets 230 are left in place, facilitating the antenna wiring 130 as routed to form the first, second and third detection loops 220, 222 and 224. The respective ends of the first, second and third detection loops 220, 222 and 224 may be received within two rubber blocks 240 that may be placed at the connection terminal location 226. In one example, the rubber blocks 240 may each have three holes (e.g., blind holes) provided therein to enable the rubber blocks 240 to accommodate the wire ends of the detection loops and prevent the wire ends from being bound together with acrylic during the casting process.

Thereafter, a seal 250 may be placed on the cable routing fixture 200. In some embodiments, the seal 250 may be rubber, although the seal may be made of any known substance in the art. FIG. 5 illustrates an exploded view of the casting mold assembly that may be employed for the casting process. As can be appreciated from FIG. 5, the cable routing fixture 200 may be a bottom sheet of tempered glass and the seal 250 (e.g., rubber seal 250) may extend around a periphery of the first, second and third detection loops 220, 222 and 224 to fully bound the antenna wiring 130. Thus, for example, the cable routing fixture 200 may lie in a first plane, and the first, second, and third detection loops 220, 222 and 224 may lie in a second plane along with the rubber seal 250. In one example, the rubber seal 250 may be spaced apart from the external periphery of the antenna wiring 130 and may substantially enclose an entirety of the antenna wiring 130 therein. Meanwhile, a top fixture 260, which may be a pane of tempered glass (i.e., a second plate) substantially similar to the cable routing fixture 200, may be placed over the top of the rubber seal 250 in a third plane that is substantially parallel to the first and second planes. The rubber seal 250 and the top fixture 260 may each have external peripheral shapes that are similar to the external peripheral shape of the cable routing fixture 200. In one example, the shape of the cable routing fixture 200 may be rectangular. However, other shapes could be employed. Additionally, the rubber seal 250 may have an internal periphery defining a hollow portion therein, which may also have a substantially rectangular, or other, shape. In any case, the internal periphery of the rubber seal 250 may substantially define a desired shape for the finished molded product that results from the casting process.

As shown in FIG. 6, the top fixture 260 and the cable routing fixture 200 may form two glass panes spaced apart from each other by a width of the rubber seal 250. In this example, the antenna wiring 130 may be housed within the top fixture 260 and the cable routing fixture 200. The rubber blocks 240 and the engagement brackets 230 may each have thicknesses that are equal to or less than the thickness of the rubber seal 250. As such, the antenna wiring 130 may be held within a casting mold forming a void space 270 bounded by the top fixture 260 and the cable routing fixture 200 on the top and bottom, respectively, and bounded by the rubber seal 250 on the sides.

After the casting mold is formed by collapsing the components shown in FIG. 5 together, a liquid material can be poured into the void space 270. The liquid material may be acrylic, e.g., polymethyl methacrylate or PMMA. In some embodiments, a pour gate 280 may be formed in a portion of the rubber seal 250 as shown in FIG. 6, which shows a side view of a filled casting mold 300 in a fully assembled state. The pour gate 280 may be formed in an edge of the rubber seal 250 that is proximate to a location of the rubber blocks 240. When the void space 270 is filled with the liquid material, the entire assembly (e.g., the filled casting mold 300) may be baked in an oven at a predetermined temperature and for a predetermined length of time. During the baking process, the engagement brackets 230 may be fused with the liquid material to integrate them together. As such, the engagement brackets 230 may essentially disappear as separate components and be incorporated into a sheet 290 (e.g., an acrylic sheet 290) formed from the combination of the baked liquid material and engagement brackets 230 fused therewith. The liquid material may harden between the loop wires to ensure that there is no undesirable electrical connection between the wires of the first, second and third detection loops 220, 222 and 224.

After the liquid material solidifies, and the top fixture 260 is removed, the sheet 290 of FIG. 7 remains. As can be seen in FIG. 7, the rubber seal 250 and the rubber blocks 240 may remain within the sheet 290. In other examples, however, the rubber seal 250 and rubber blocks 240 may be removed. The cable routing fixture 200 may be removed at this point, such that, as shown in FIG. 8, only the rubber seal 250 and the rubber blocks 240 remain with the sheet 290. Regardless of when the rubber blocks 240 are removed, the outline of the sheet 290 may be milled so that the rubber seal 250 is removed leaving the acrylic sheet 290 with the antenna wiring 130 integrated therein, as shown in FIG. 9. The sheet 290 may then be installed vertically into a pedestal (as shown in FIG. 1), and the antenna wiring 130 may be coupled to control circuitry therein.

As a result of the process described above, the amount of milling may be reduced and a lower cost coil carrier (e.g., the acrylic sheet 290) may be provided. In addition, cable routing time may be reduced, because it is much easier to route cable earlier in the process, rather than milling routing channels through solid material and attempting to feed cables through the milled channels.

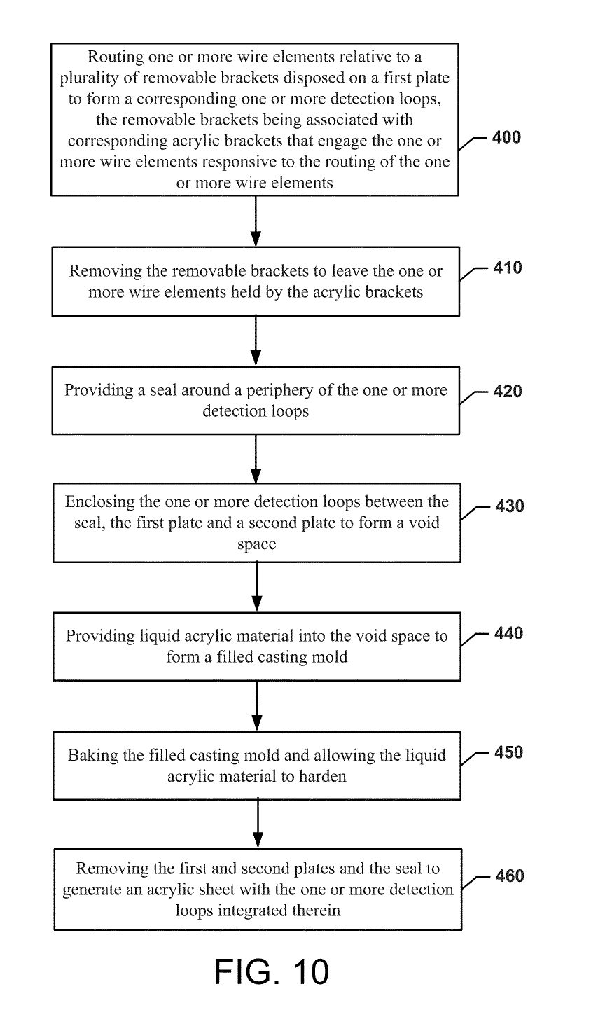

FIG. 10 illustrates a block diagram of a process for integrating antenna wiring into a sheet (e.g., an acrylic sheet) during a casting process, in accordance with an exemplary embodiment. The method includes routing one or more wire elements relative to a plurality of brackets disposed on a first plate to form a corresponding one or more detection loops at operation 400. The brackets may be associated with corresponding engagement brackets that engage the one or more wire elements responsive to the routing of the one or more wire elements. The method may further include removing the removable brackets to leave the one or more wire elements held by the acrylic brackets at operation 410, providing a seal around a periphery of the one or more detection loops at operation 420, and enclosing the one or more detection loops between the seal, the first plate and a second plate to form a void space at operation 430. The method may also include providing liquid material into the void space to form a filled casting mold at operation 440, baking the filled casting mold, and allowing the liquid material to harden at operation 450. At operation 460, the first and second plates are removed, and the seal to generate a sheet with the one or more detection loops is integrated therein.

In some embodiments, the operations described above may be modified, amplified or augmented in various optional ways. For example, in some cases, providing the seal may include providing a rubber seal placed on the first plate to lie in a same plane as the one or more detection loops. In an example embodiment, the method may further include providing a rubber block at each corresponding end of the one or more wire elements prior to enclosing the one or more detection loops. In such an example, the rubber blocks may have a thickness less than or equal to a thickness of the seal. In some cases, removing the seal may include milling an outline of the acrylic sheet, and wherein the rubber blocks are removed after the baking In an example embodiment, as an alternative or in addition to the modifications above, the first plate and the second plate may be glass plates. Additionally or alternatively, the liquid acrylic material and the acrylic brackets may fuse together responsive to the baking Additionally or alternatively, providing the liquid acrylic may include filling the void space via a pour gate disposed in a portion of the seal. In an example embodiment, forming the one or more detection loops may include forming a first detection loop, a second detection loop and a third detection loop such that the first, second and third detection loops lie adjacent to each other in substantially a same plane that is parallel to a plane in which the first plate lies.

Example embodiments may provide a security device detection gate. This gate can effectively protect products, to which detectable security devices are attached, from theft by alarming if the security device is not removed from the product before passing through the security device detection gate. However, example embodiments may further enable the provision of the transparent antenna support member portion of the security device detection gate with the antenna wiring integrally formed therein. Thus, by integrally forming the antenna wiring inside the transparent antenna support member, the cost and complexity of producing the security device detection gate may be reduced, while the designer can still employ a wide variety of options for designing the aesthetic appearance of the transparent antenna support member.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A method, comprising:
routing a wire element relative to a plurality of engagement brackets disposed proximate to a first plate to form one or more detection loops;
providing a seal around a periphery of the one or more detection loops;
enclosing the one or more detection loops between the seal, the first plate, and a second plate to form a void space;
providing liquid material into the void space to form a filled casting mold;
baking the filled casting mold and allowing the liquid material to harden; and
removing the first plate and the second plate to generate a sheet with the one or more detection loops integrated therein.

2. The method of claim 1, wherein providing the seal comprises providing a rubber seal placed on the first plate to lie in a same plane as the one or more detection loops.

3. The method of claim 2, further comprising providing a rubber block at an end of the wire element prior to enclosing the one or more detection loops, the rubber blocks having a thickness less than or equal to a thickness of the seal.

4. The method of claim 3, wherein removing the seal comprises milling an outline of the sheet, and wherein the rubber blocks are removed after the baking.

5. The method of claim 1, wherein the first plate and the second plate comprise glass plates.

6. The method of claim 1, wherein the engagement brackets or the liquid material are acrylic.

7. The method of claim 1, wherein providing the liquid material comprises filling the void space via a pour gate disposed in a portion of the seal.

8. The method of claim 1, wherein forming the one or more detection loops comprises forming a first detection loop, a second detection loop, and a third detection loop, such that the first, second, and third detection loops lie adjacent to each other in substantially a same plane.

9. The method of claim 8, wherein the engagement brackets are provided at respective corners of each of the first detection loop, the second detection loop, and the third detection loop to define corresponding shapes of the first detection loop, the second detection loop, and the third detection loop.

10. A gate device comprising:
a pedestal housing control circuitry for the security device detection gate and providing a base for supporting the security device detection gate proximate to an exit of a retail store;
a transparent antenna support member supported in a vertical orientation relative to a ground plane upon which the pedestal is placed; and
antenna wiring provided integrally within the transparent antenna support member during a casting process that forms the transparent antenna support member.

11. The gate device of claim 10, wherein the antenna wiring comprises a wire element routed within the transparent antenna support member to define one or more detection loops.

12. The gate device of claim 11, wherein the wire element is routed relating to a plurality of engagement brackets.

13. The gate device of claim 12, wherein the engagement brackets are fused with liquid material of the transparent antenna support member during baking of a filled casting mold used in the casting process.

14. The gate device of claim 13, wherein the engagement brackets are initially held by corresponding removable brackets fixed to a first plate forming a portion of a casting mold, and wherein the removable brackets are removed prior to filling the casting mold.

15. The gate device of claim 14, wherein the casting mold comprises the first plate, a seal substantially defining a shape of the transparent antenna support member, and a second plate.

16. The gate device of claim 13, wherein the engagement brackets or the liquid material are acrylic.

17. The gate device of claim 11, wherein the one or more detection loops include a first detection loop, a second detection loop, and a third detection loop, and wherein the first, second, and third detection loops lie adjacent to each other and in a same plane defined by the transparent antenna support member.

18. The gate device of claim 14, wherein the engagement brackets are provided at respective corners of each of the one or more detection loops to define corresponding shapes of the one or more detection loops when the removable brackets are removed.

19. A system comprising:
a security tag attached to a commercial product;
a security device detection gate configured to detect the security tag responsive to movement of the security tag proximate to the security device detection gate, the security device detection gate comprising:
a pedestal housing control circuitry for the security device detection gate and providing a base for supporting the security device detection gate proximate to an exit of a retail store;
a transparent antenna support member supported in a vertical orientation relative to a ground plane upon which the pedestal is placed; and
antenna wiring provided integrally within the transparent antenna support member during a casting process that forms the transparent antenna support member.

20. The system of claim 19, wherein the antenna wiring comprises a wire element routed within the transparent antenna support member to define one or more detection loops.
